(19) United States
(12) Patent Application Publication
(10) Pub. No.: US 2006/0263267 A1
(43) Pub. Date: Nov. 23, 2006

(54) In-field saline solution warming graduate

(76) Inventors: Lori L. Witz, Hinckley, MN (US); Roy D. Witz, Hinckley, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 11/131,664

(22) Filed: May 17, 2005

(51) Int. Cl. B01L 3/00

(52) U.S. Cl. 422/102

(57) ABSTRACT

An infield sterilizable, saline solution warming graduate for a surgical operating room includes a stainless metal graduate. The graduate has an outside wall suitably with a handle, an inside wall forming an open container with a saline solution sensor and a solution temperature sensor. The graduate has a base with a first DC electrical connector, status lights and a housing for enclosing a heater and a control circuit. A DC power source with a second DC electrical connector is connectable with the first base DC electrical connector for energizing the control circuit, sensors, lights and heater.

### BACKGROUND OF THE INVENTION

This invention relates to saline solution irrigation performed during invasive procedures within operating rooms, and more particularly, to an in-field sterilizable, saline solution warming graduate.

Invasive procedures typically performed within operating rooms require irrigation with warmed, suitably 104° Fahrenheit, saline solution. This is necessary as organs are exposed and the procedure area is often obscured by blood. Irrigation not only baths the wound and organs but also cleanses the entire tissue area where the invasive procedure is being performed.

Desirably all invasive operating procedures are performed within an operating suite. The operating suite is divided into three zones: unrestricted areas, semi-restricted areas and restricted areas or operating rooms. The unrestricted area usually includes a central control point to monitor the entrance of personnel, patients and equipment. Other unrestricted areas include corridors, waiting rooms, reception desk, staff locker rooms and pre-operative holding areas for ambulatory surgery patients. Street clothing is permitted in unrestricted areas which are isolated from the semi-restricted areas and restricted areas by doors.

The semi-restricted areas are usually designated as internal holding areas, the recovery room and supply rooms. Traffic in these areas is limited to patients and personnel in the appropriate attire including scrub suits, hair protection and in some instances coverings for shoes.

In the semi-restricted areas the saline solution is held in warming cabinets 4 as shown in FIG. 1. The saline solution is packaged within plastic bottles 6 and warmed within the warming cabinets 4 suitable to approximately 104° Fahrenheit or 40° Centigrade.

Bottled sterile saline solution 6 maybe obtained from Baxter of Round Lake, Ill. Baxter maintains that the plastic bottled saline solutions for irrigation maybe heated to 40° centigrade or 104° Fahrenheit for a period of no longer than 14 days. Thereafter the saline solution container should be removed from the warming cabinet 4 and identified as having been warmed and should not be subsequently returned to the warmer 4. This requirement is believe to prevent any effusion from the plastic bottles 6 into the saline solution.

The operating suite, particularly the operating rooms are intended to remain as sterile as possible to prevent cross contamination. The contamination may consist of airborne microbial contamination. Airborne microbial contamination occurs when such contaminants flow into the operating suite and operating rooms. Another form of contamination is microbial shedding which is minimized by surgical scrubs, gloves, shoe covers and hair covers. Nonetheless, microbial shedding occurs and increases with activity and movement which should be minimized within the operating suite.

To prevent airborne microbial contamination and to minimize microbial shedding the operating suite, and particularly the operating rooms, are equipped with ventilation systems that remove air from the rooms and replaces it with fresh or filtered air each hour. Current recommendation requires 15 air exchanges per hour with three of these exchanges being fresh air. This exchange process creates a negative pressure gradient between the sterile operating room and the outside areas. Doors to the operating rooms should be closed, except during movement of the patients, personnel, supplies and equipment to maintain this gradient, to facilitate appropriate air exchange and to assist in temperature and humidity regulation of the peri-operative area as a whole. Leaving a door open can disrupted pressurization and cause turbulent air flow that could increase airborne contamination. Most importantly, traffic and movement should be minimized during invasive procedures.

Current practice would place supplies and equipment within the semi-restricted area of an operating suite. Here is where a fluid warmer 6, as shown in FIG. 1, would be located. Such warmers or warming cabinets 6 maintain the saline solution in the plastic bottles at 104° Fahrenheit until used in the operating room or until expiration of the 14 day period. These warmers 6 are expensive and maybe obtained from Steris Corporation of Mentor, Ohio. During operation procedures and when a patient wound irrigation becomes necessary, a circulating nurse would leave the operating room to the semi-restricted area and obtain a warmed saline solution bottle 6 and return to the operating room where the saline solution is poured into a graduate 8 such as those manufactured by Vollrath of Sheboygan, Wis. Then the surgical scrub or assistant would pour the saline solution for the irrigation procedure provided that the solution is at the correct temperature of 104° Fahrenheit. Sometimes the circulating nurse will wrap the graduate 8 or plastic bottles of the saline solution 6 in a warm blanket to keep the solution warm before use. If the saline is prepared too early or it gets cold, the saline solution is dumped into the splash basin with instruments so that the graduate can be refilled with warmer saline solution. However, saline is a contraindication for instrument soaking as it causes pitting in the metal and damage to the instruments.

The demand for properly warmed saline solution for irrigation during invasive procedures is critical and requires significant traffic by personnel and nurses to travel back and forth from the operating room to the semi-restricted room where the fluid warmer cabinet 4 is located thereby increasing chances of cross contamination by both airborne microbial and microbial shedding.

There is a need for infield saline solution warming graduate that maybe sterilized and brought into the operating room along with saline solution plastic bottles 6 and remain there for use during the entire invasive procedure without excessive traffic or opening doors.

### SUMMARY OF THE INVENTION

An infield sterilizable, saline solution warming graduate for a surgical operating room includes a stainless metal graduate. The graduate has an outside wall suitably with a handle, an inside wall forming an open container with a saline solution sensor and a solution temperature sensor. The graduate has a base with a first DC electrical connector, status lights and a housing for enclosing a heater and a control circuit. A DC power source with a second DC electrical connector is connectable with the first base DC electrical connector for energizing the control circuit, sensors, lights and heater.

The principal object and advantage of the present invention is the elimination of expensive warming cabinets in the semi-restricted area of an operating suite.

Another object and advantage of the present invention is that the 14-day life of warmed saline solution in plastic bottles is now eliminated thus conserving saline solution and providing the solution on demand within the operating room.

Another object and advantage of the present invention is the minimization of traffic and hence less potential for airborne contamination and microbial shedding.

Another object and advantage of the present invention is that the graduate provides a status light when the solution is at the appropriate temperature thereby eliminating the need for personnel to put their fingers in the saline solution to test for solution temperature thereby eliminating the guess work of solution temperature.

Another object and advantage of the present invention is that fresh saline solution is always guaranteed and completely eliminates the risk of any re-dated saline solution finding it way to the operating suite.

Another object and advantage of the present invention is that more floor space is available within the operating suite and electrical costs are curbed by warming the saline solution on demand just prior to invasive procedures.

Another object and advantage of the present invention is that it reduces labor previously required to check expiration dates on the saline solution bottles, to rotate the bottles and no need to have personnel leave the operating room to retrieve saline bottles from the cabinet creating operating room down time waiting for the solution.

Another object and advantage of the present invention is that the saline solution plastic bottles have their shelf life extended as they are not undergoing constant warming during their 14-day life period.

Another object and advantage of the present invention is the graduate assembly is cordless and of a fully sterilizable design.

### BRIEF DESCRIPTION OF THE DRAWINGS

FIG. 1 is a prior art view of a warming cabinet for use of warming saline solution in plastic bottles;

FIG. 2 is a partially broken away view of a conventional graduate used in the operating room;

FIG. 3 is a partially broken away, exploded view of the in-field sterilizable, saline solution warming graduate of the present invention; and

FIG. 4 is a flow chart for the operation of the graduate under the influence of the control circuit.

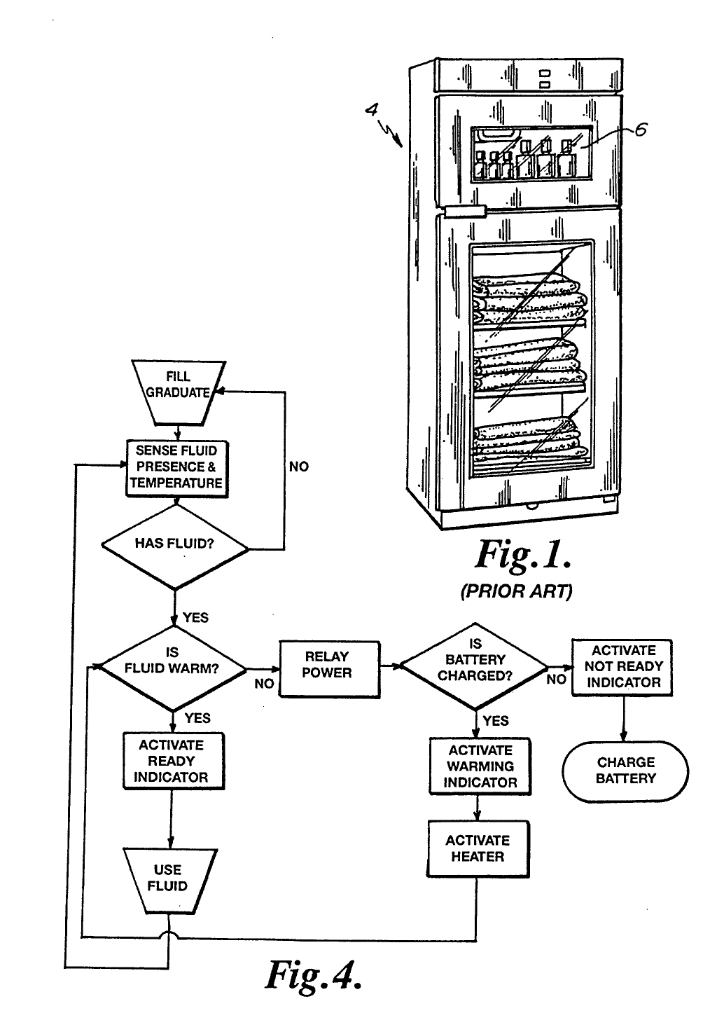

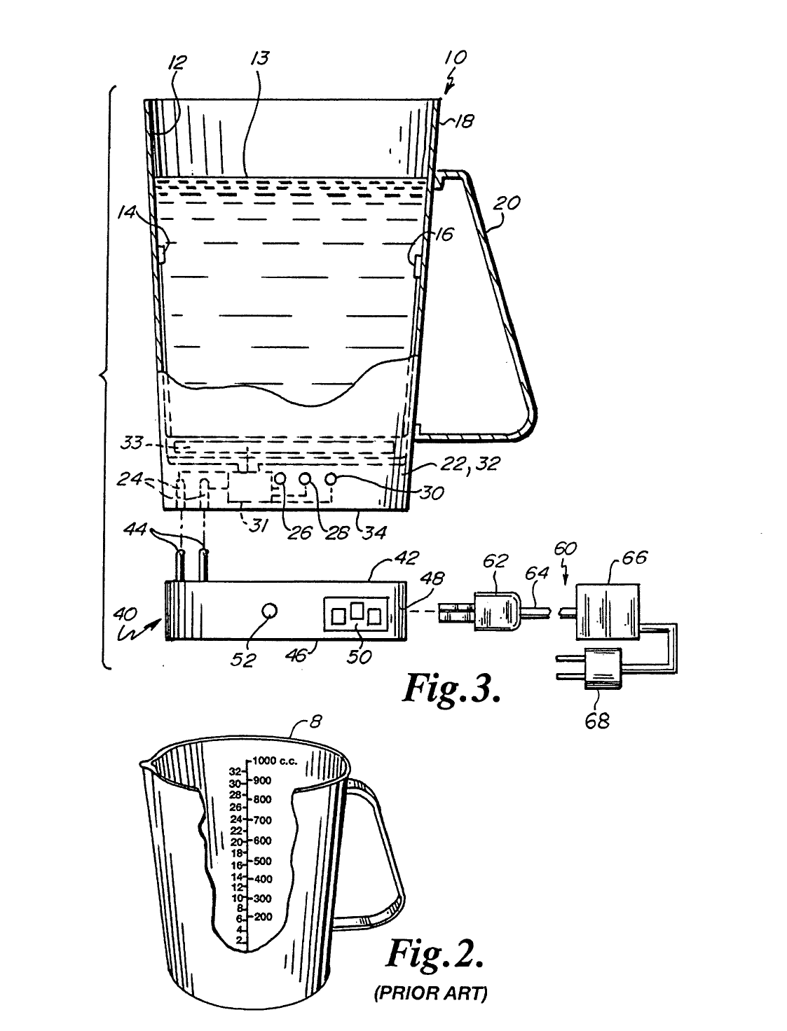

### DETAILED DESCRIPTION OF THE INVENTION

Referring to FIGS. 3 and 4, the in-field sterilizable, saline solution warming graduate 10 of the present invention maybe appreciated. The graduate 10 connects to a sterilizable battery pack 40 which may be recharged upon demand by the charging unit 60.

More specifically, the graduate 10 includes an inside wall or container 12 where the saline solution 13 is poured from plastic bottles 6 already in the restricted area of the operating suite. Inside the container 12 is located a fluid sensor 14 which maybe obtained from Scientific Technologies, Inc. of Freemont, Calif. Also within the container 12 is a temperature sensor 16 which may be obtained from VetaTHERM of Shrewsbury, Mass.

The container has an outside wall 18 suitably with a handle 20 for gripping of the graduate 10. The graduate 10 has a base 22 with a DC electrical socket or connector 24. The base 22 also has a red LED 26 indicating “not ready”; a yellow LED 28 indicating “warming”; and, a green LED 30 indicating “ready for use” of the properly warm saline solution 13.

A control circuit 31 is within a housing 32 of base 22 along with a heater 33. The heater 33 maybe a wire wound silicon rubber or a mica-style heater both of which may be obtained from Minco Products, Inc. of Minneapolis, Minn. Minco also has temperature controllers. The control circuit 31 maybe a smart or dumb microprocessor readily found in the market place. The graduate 10 rests on its bottom wall 34.

A battery pack or DC power source 40 suitably is rechargeable and sterilizable as it is hermitically encased in durable plastic that will resist the effects of steam at 270° Fahrenheit in an autoclave for approximately ten minutes. The battery packs 40 can be obtained from Stryker headquartered in Kalamazoo, Mich. The battery pack 40 has a top wall 42 which will securely support the bottom wall 34 of graduate 10 by its DC power prongs or connectors 44 to be fit into the electrical socket 24. The battery pack then rests on its bottom wall 46 suitably on a table in the operating room without the need for electrical cords. The battery pack 40 has a side wall 48 which has a DC charging socket or connector 50 and a “charged” or “charging” indicator LED 52.

The charging unit 60 is well known and includes a DC charging plug or connector 62 insertable into the DC charging socket 50 of the battery pack 40. Plug 62 extends by way of cord 64 to power converter or charger 66, which is well known, from which extends an AC plug 68 suitably for use with a 110 volt wall outlet.

FIG. 4 is a flow chart showing the operation of the in-field sterilizable, saline solution warming graduate 10 of the present invention. Initially the graduate 10 and battery pack 40 are sterilized, packaged and stored in the semi-restricted area of the operating suite. When needed, one or more of the graduates 10 are brought into the operating room from the semi-restricted area along with sterile bottles of saline solution 6 adequate in number for use in irrigation during the invasive procedure.

Next, the battery power prongs 44 are inserted into the electrical socket 24 of the graduate and the red LED light comes on indicating that it is not ready. Next, the nurse pours saline solution 13 into the container 12 of the graduate 10 which energizes the fluid sensor 14. The temperature sensor 16 senses that a solution 13 is not warm and the control circuit 13 energizes the heater 33 turning on the yellow LED indicating the saline solution 13 is warming while turning off the red LED light. Once the temperature sensor 16 senses that the saline solution is 104° Fahrenheit, the yellow LED 28 is turned off and the green LED 30 is turned on under the influence of the control circuit indicating that the saline solution 13 is now ready for irrigation procedures.

After the saline solution 13 is poured out of graduate 10 for irrigation use, the control circuit de-energizes the green LED and re-energizes the red LED until more saline solution 13 is put into the container portion 12 of the graduate 10 after which the yellow LED 28 indicates warming until the solution 13 reaches a temperature of 104° Fahrenheit after which the green LED 30 is energized indicating readiness and proper temperature of the saline solution 13. This cycle is repeated until the surgical procedure and need for irrigation fluids is completed.

Thereafter and outside the operating room, the battery pack 40 and graduate 10 maybe sterilized in an autoclave after the battery pack 40 has been recharged with the charging unit 60. Next the graduate assembly 10 is packaged sterile and located in the semi-restricted area of the surgical suite until it is needed within the operating room.

It is to be understood that the proceeding specification is illustrative and not restrictive and that the following claims are intended to cover the invention without departing from the spirit and scope of applicants' general inventive concept.

1. A in-field sterilizable, saline solution warming graduate for a surgical operating room, comprising:
a) A graduate having an outside wall with a handle, an inside wall forming an open container with a saline solution sensor and a solution temperature sensor, and a base with a first DC electrical connector, status lights and a housing for a heater and a control circuit; and
b) a DC power source with a second DC electrical connector connectable with the graduate first connector for energizing the control circuit, sensors, lights and heater.

2. The graduate of claim 1, wherein the DC power source is a battery pack.

3. The graduate of claim 1, wherein the battery pack is rechargeable, sterilizable and hermetically sealed.

4. The graduate of claim 3, wherein the battery pack has a first charging connector and a connectable charging unit.

5. The graduate of claim 1, wherein the status lights comprise a red LED for not ready status, a yellow LED for warming status and a green LED for ready status.

6. The graduate of claim 1, wherein the base of the graduate removably and securely sits on top of the DC power source.

7. A in-field sterilizable, saline solution warming graduate for a surgical operating room, comprising:
a) A graduate having an outside wall with a handle, an inside wall forming an open container with a saline solution sensor and a solution temperature sensor, and a base with a first DC electrical connector, status lights and a housing for a heater and a control circuit; and
b) A battery pack with a second DC electrical connector connectable with the graduate first connector for energizing the control circuit, sensors, lights and heater.

8. The graduate of claim 7, wherein the battery pack is rechargeable, sterilizable and hermetically sealed.

9. The graduate of claim 8, wherein the battery pack has a first charging connector and a connectable charging unit.

10. The graduate of claim 7, wherein the status lights comprise a red LED for not ready status, a yellow LED for warming status and a green LED for ready status.

11. The graduate of claim 7, wherein the base of the graduate removably and securely sits on top of the DC power source.

12. A in-field sterilizable, saline solution warming graduate for a surgical operating room, comprising:
a) A graduate having an outside wall with a handle, an inside wall forming an open container with a saline solution sensor and a solution temperature sensor, and a base with a first DC electrical connector, status lights and a housing for a heater and a control circuit;
b) A sterilizable, rechargeable battery pack with a second DC electrical connector connectable with the graduate first connector for energizing the control circuit, sensors, lights and heater, and a first charging connector; and
c) A connectable charging unit for the battery pack.

13. The graduate of claim 12, wherein the status lights comprise a red LED for not ready status, a yellow LED for warming status and a green LED for ready status.

14. The graduate of claim 12, wherein the base of the graduate removably and securely sits on top of the DC power source.
